(19) United States
(12) Patent Application Publication
(10) Pub. No.: US 2017/0367482 A1
(43) Pub. Date: Dec. 28, 2017

(54) EDGE STRIP

(71) Applicant: DOELLKEN-KUNSTSTOFFVERARBEITUNG GMBH, Gladbeck (DE)

(72) Inventors: Jordanis PETRAKIS, Wuppertal (DE); Peter SCHULTE, Iserlohn (DE); Stephan SCHUNCK, Muenster (DE)

(21) Appl. No.: 15/541,981

(22) PCT Filed: Jan. 27, 2016
(86) PCT No.: PCT/EP2016/051617

§ 371 Date: Jul. 13, 2017

(30) Foreign Application Priority Data
Feb. 19, 2015 (DE) 202015100800.7

(51) Int. Cl. A47B 96/20; B32B 27/08; B32B 3/30

(52) U.S. Cl. CPC A47B 96/201; A47B 96/206; B32B 3/30; B32B 27/08; A47B 2096/208; B32B 2307/414; B32B 2451/00; B32B 2479/00; B32B 2307/412

(57) ABSTRACT

The invention relates to an edge strip (1) for fixing to a workpiece, in particular for the narrow surface coating of furniture boards, worktops, or similar material boards (2), having a base layer (3) of a thermoplastic, the upper side (3a) of which is structured, and a covering layer (4) of a transparent or translucent thermoplastic which is arranged on the base layer (3), wherein the upper side (4a) of the covering layer (4) completely or partly forms the visible face of the edge strip and the underside (4b) of said covering layer (4) completely or partly adjoins the profiled upper side (3a) of the base layer (3).

The invention relates to an edge strip for fixing to a workpiece, particularly for covering the narrow edge of a furniture panel, a ccountertop, or similar material panel. Such an edge strip or cover strip is also referred to simply as an edging, edge band, or even edge veneer. It is used preferably for covering the narrow edge or front face of a material panel, that is, a laminar workpiece such as a furniture panel or work plate (for example kitchen counter). Such a material panel can for example be a wooden panel or wood-based panel (for example chipboard, fiberboard, or the like), or even a composite panel. The edge strip is fastened to the material panel in a conventional manner by for example a hot-melt adhesives. However, the edge strips can also already be provided with a meltable layer or functional layer during production that is then melted during processing with suitable sources (for example laser radiation, hot air, plasma, microwave, or the like). The edge strip is preferably made of a thermoplastic plastic.

An edge strip of the type described above is known, for example, from EP 0 857 442 [U.S. Pat. No. 5,989,657]. The edge strip has a transparent strip body or strip core having an inner face carrying a decorative coating or paint coating. This edge strip is also referred to in practice as a “3-D edge.” The edge is fixed with its inner side or face on which the decorative coating or paint coating is arranged to the outer face of the furniture panel, so that the decorative element remains visible through the transparent strip body, particularly even after subsequent material-removing surface processing of the plastic strip. The outer face and/or inner face of the transparent strip can be provided with an embossing, thus enabling the surface to be structured to a certain degree.

DE 20 2014 103 706 describes a 3-D edge in which lamellae are integrated into the strip body, so that the visual impression of the strip depends particularly on the viewing angle.

Moreover, a profile strip with a transparent strip core is known from DE 200 16 842 U1 in which a decorative strip is provided on the interior of the profile strip that is enclosed by the profile strip. This is intended to prevent the decorative strip from being damaged during processing and particularly during subsequent profiling. The known 3-D edges (for example according to EP 0 857 442) have proven themselves to be outstanding in practice, but they have room for improvement in terms of their construction and the variety of their design. This is where the invention comes in.

It is the object of the invention to provide an edge strip of the type described above that is characterized by a special design and that is simple and cost-effective to manufacture without compromising its anchorability and cleanability.

To attain this object, the invention teaches an edge strip for fixing to a workpiece, particularly for covering the narrow edge of a furniture panel, work plate, or similar material panel, with
a base layer made of a thermoplastic plastic whose outer face is structured and
a cover layer on the base layer made of a transparent or translucent thermoplastic plastic,
   the cover layer forming the visible surface with its outer face and at least in some areas with its inner face but preferably being completely in full surface contact with the structured outer face of the base layer.

“Outer face” refers here to the side of the edge strip that forms the visible side when mounted on a workpiece, and “inner face” refers to the side facing toward the workpiece or the processing surface in the mounted state. Preferably, the base layer and the cover layer are unitarily connected to one another. Especially preferably, the base layer and the cover layer are produced by coextrusion or post-coextrusion or by aftercoating.

The invention proceeds in this regard from the discovery that a 3-D edge with special visual characteristics in terms of a surface structuring can be manufactured by not applying the structuring directly to the (transparent) surface of the edge strip, but rather by providing a base layer with a structured surface that is covered with a transparent or translucent cover layer. Consequently, the structured base layer is visible through the transparent or translucent cover layer, thereby creating the overall impression of a structured edge strip. Nevertheless, an edge strip with a flawless, flat surface can be provided, which results in an edge strip that is very easy to clean overall. Since the nonflat structure of the base layer is covered by the cover layer, the structure is also provided with outstanding protection from damage.

Here, the “structuring of the base layer” refers to a structure that is visible in the transverse direction of the edge, that is, the nonplanar raised areas and depressions of the structure extent along the longitudinal direction of the edge strip (in the extrusion direction, for example), thereby making such a structure very easy to produce during the manufacturing process through the appropriate configuration of the extrusion die.

The cover layer covers the structured base layer, so the cover layer is preferably embodied with an inner face whose structuring extends over the entire width or, optionally, a portion of the width in a manner that is complementary to the structuring of the outer face of the base layer. A structured boundary layer is thus achieved between the cover layer and the base layer. Surface structures that are visible, deep, and striking can certainly be produced.

It is thus possible, for example, for the base layer to be opaque and hence not transparent and not even translucent. The base layer, with its structured surface, is then visible through the transparent or translucent cover layer. In a modified embodiment, it is possible for the base layer to also be transparent or translucent but optionally with a different coloration or degree of transparency, so that the base layer is visible with its structured surface through the cover layer due to the differing optical characteristics.

Furthermore, it is possible for the outer face of the base layer to be provided with a decorative element, for example a decorative imprint, a decorative film, or a paint coating that is visible through the cover layer. As a whole, a wide range of possibilities exists within the scope of the invention for achieving a 3-D edge with embedded structure.

What is more, it is also possible for the inner face of the base layer to be provided with a decorative element, for example a decorative imprint, a decorative film, or a paint coating. This option is particularly advantageous if not only the cover layer but also the base layer is made of a transparent or translucent material, so that the inner face of the decorative element is then visible through the cover layer and the base layer. As a result of the optionally different visual characteristics of cover layer and base layer, however, the “inner” structure is given special importance in this embodiment as well.

The inner face of the base layer is used for fixing to a workpiece, for example a narrow edge of a furniture panel. The fixation to the workpiece can be achieved in a manner known per se. It is thus possible for the inner face of the base layer to be provided with an adhesion-promoting layer, thereby enabling subsequent fastening using conventional adhesion. Alternatively, it lies within the scope of the invention for the inner face of the base layer to be provided with a meltable layer or functional layer that can be melted during processing using suitable heat sources, for example laser radiation, hot air, plasma, or the like. If the inner face of the base layer is provided with the above-mentioned decorative element, it will readily be understood that the adhesion-promoting layer or the meltable layer is applied to the lower side or inner face of this decorative element.

In that case, it is advantageous if the inner face of the base layer is flat, that is neither profiled nor structured.

Moreover, it is advantageous for the outer face of the cover layer, with the exception of the edges, to be flat or smooth or arched (but nonetheless smooth) and consequently not profiled and not structured. Optionally, however, it also lies within the scope of the invention for the outer face of the cover layer to be provided with an imprint or similar structuring.

Moreover, the outer face of the cover layer can be provided with a finish, for example a film coating (for example metallization) or also a paint coating.

Inherently known plastics can be used as the thermoplastic plastics employed for the manufacture of the edge strip. For instance, the base layer can be made of PMMA, PS, ABS, PVC, PC, PET, TPU, PP, PP copolymer, PE copolymer, EVA, EMA, etc.

The cover layer can be made of PMMA, PS, ABS, PVC, PC, PET, TPU, PP, PP copolymer, PE copolymer, EVA, EMA, etc. Especially preferably, the following combinations of materials can be used:

Base layer of PVC, cover layer of TPU.

Base layer of PS, cover layer of PMMA.

Base layer of PMMA, cover layer of PMMA.

Base layer of ABS, cover layer of PMMA,

Base layer of ABS, cover layer of EVA,

Base layer of EVA, cover layer of PMMA,

Base layer of PP cover layer of PP copolymer.

The thermoplastic plastics used for the base and cover layer can have different relative hardnesses (hard-hard, hard-soft, soft-soft, soft-hard). This means that the base layer can be harder than the cover layer or softer than the cover layer, or that the base layer and cover layer can have the same hardness.

It lies within the scope of the invention for the structure layer on the one hand and the cover layer on the other hand to be made of different thermoplastic plastics. It is at least advantageous if the thermoplastic material of the base layer and the thermoplastic plastic of the cover layer have different visual characteristics so that the desired visual characteristics are achieved through appropriate polymer pairings and/or appropriate additives.

The thickness of the edge strip be 1 mm to 10 mm. The width of the edge strip can be 2 mm to 100 mm. The inventive construction of base layer and cover layer can produce structures with great structural depth. For instance, the overall depth or overall thickness of the structure can be up to ⅔ of the overall thickness (or overall height) of the edge strip.

The separation between base layer and cover layer can be at different depths. For instance, the average thickness of the cover layer can be 10% to 80% of the average thickness of the base layer. The structuring can be preferably an angular or jagged structure extending over the width of the edge strip that consequently has several points of discontinuity. It also lies within the scope of the invention for the structuring to form a concave or convex structure in the sense of a profile. The structure can thus for example form a reflector for focusing light.

Alternatively, it also lies within the scope of the invention for the structuring to be a groove that is used to receive LED light strips, strings, fabric tapes, fibers, metal strips, or real wood veneers, so that such LED light strips or inlaid parts can be put in place before application of the cover layer and thus integrated into the edge strip.

As a whole, the invention enables especially deep structures, contours, and spatial shapes to be integrated into the edge strip, since these structures are produced, for example, during extrusion by the cross-sectional shape of the extrusion die.

It lies within the scope of the invention for the cover layer to completely cover the base layer, so that the cover layer forms the entire visible surface of the edge strip. Alternatively, however, it also lies within the scope of the invention for the cover layer to cover the base layer only partially, so that the cover layer also forms only a portion of the visible surface and uncovered portions of the base layer are also exposed and thus form the visible surface.

The thickness distribution of the base layer to the cover layer can be symmetrical over the width of the strip or, alternatively, it can also be asymmetrical. The invention is explained in further detail below with reference to drawings that show embodiments that are only exemplary in nature.

FIG. 1 shows a furniture panel with an edge strip fixed thereto;

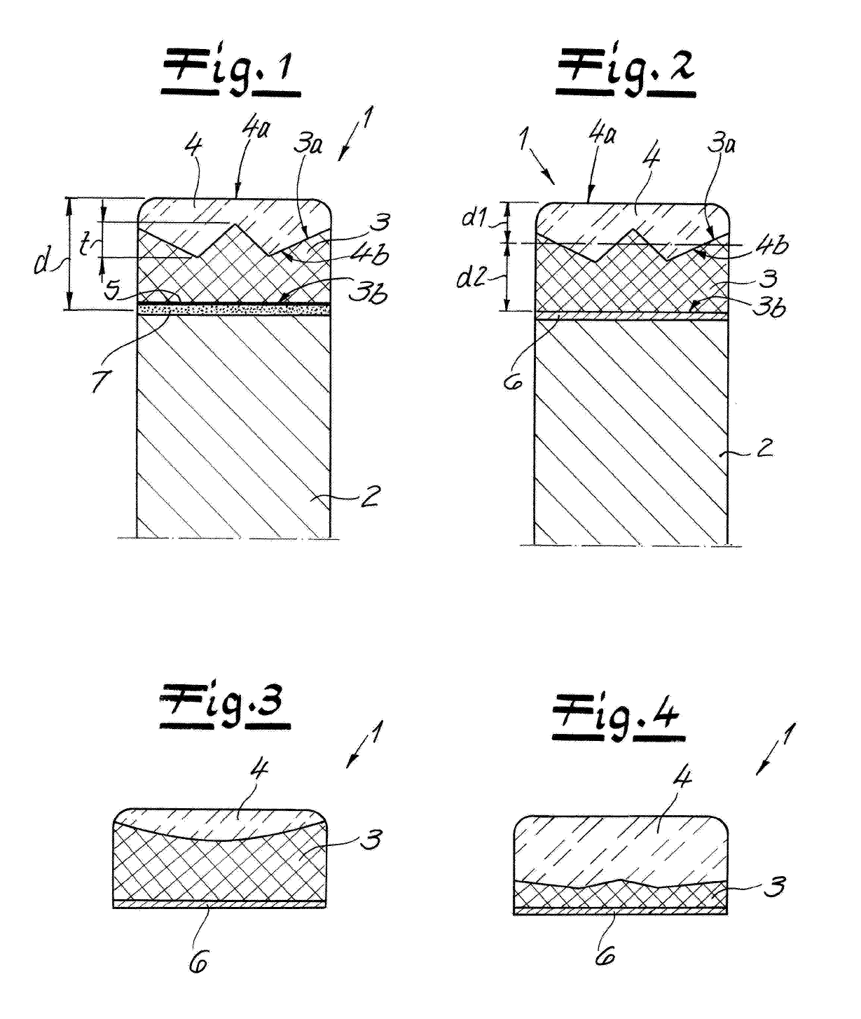

FIG. 2 shows the structure of FIG. 1 in a modified embodiment;

FIG. 3 shows another embodiment of an edge strip; and

FIG. 4 shows a modification of the embodiment of FIG. 3;

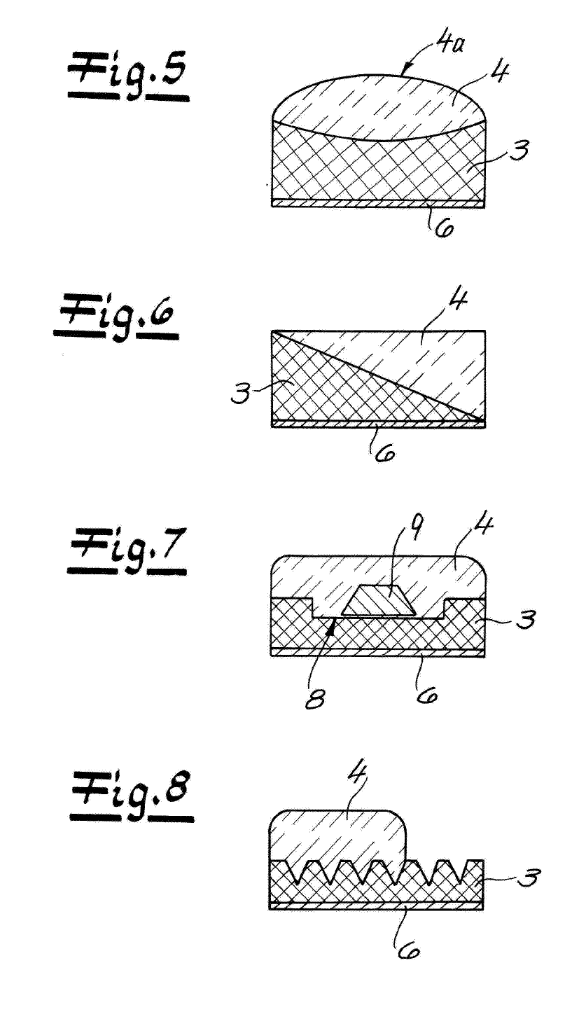

FIGS. 5 to 8 show additional embodiments of the invention.

The figures show edge strips 1 for fixing to a workpiece, particularly for covering the narrow edge of a furniture panel 2 or similar material panel.

FIG. 1 shows a schematically simplified illustration of such a furniture panel 2 with an edge strip 1 fixed to the outer edge thereof. This is a conventional furniture panel 2. The invention relates to the design of the edge strip 1.

This edge strip has a base layer 3 and a cover layer 4, each made of thermoplastic plastic, particularly through coextrusion, post-coextrusion, or even for example by aftercoating. The inner face 3b of the base layer 3 faces toward the furniture panel 2 and is used for fixation to the furniture panel 2. The outer face 3a of the base layer 3 turned away from the furniture panel 2 is structured. The cover layer 4 is on the base layer 3, with the inner face 4b of the cover layer 4 also being complementarily profiled in the illustrated embodiment. As a result, the cover layer 4 has its profiled/structured inner face 4b in surface contact with the profiled outer face 3a of the base layer 3. At least the cover layer 4 is made of a transparent or translucent thermoplastic plastic, so that the profiled outer face 3a of the base layer 3 is visible through the cover layer 4.

It is possible for the outer face 3a of the base layer 3 to be imprinted or covered with film so that this outer-face imprint or film is visible through the cover layer 4. This is not shown in the drawing. FIG. 1 shows an embodiment in which the inner face 3a of the base layer 3 is provided with an adhesion-promoting layer 5, with the edge strip 1 being fixed during processing to the furniture panel 2 using a conventional adhesive, for example a hot-melt adhesive 7.

FIG. 2 shows a modified embodiment in which the base layer 3 is precoated on its inner face with a meltable layer 6 that forms a functional layer, with this functional layer being melted by laser radiation or another heat source in order to fix the edge strip 1 to the furniture panel 2.

The structuring can be embodied in any of a variety of manners. Additional examples are illustrated in FIGS. 3 and 4, it being noted that these figures show the edge strip 1 without the furniture panel. While FIGS. 1, 2, and 4 show embodiments with angular structuring, FIG. 3 shows an embodiment in which the structuring can be concave or convex in the manner of a profile in order for example to form a reflector.

Apart from that, the figures show that the structuring can extend over a very large structure depth t. This structure depth t can be up to ⅔ of the total thickness d of the edge strip. “Structure depth t” refers to the transverse distance between the maximum raised areas and depressions of the structure. The average thickness d1 of the cover layer can be 10% to 80% of the average thickness d2 of the base layer. As explained above, the outer face 4a of the surface of the cover layer 4 is flat and smooth. This does not rule out, however, that the outer face 4a as shown in FIG. 5 has an arcuate or curved (albeit smooth) surface, for example a convexly curved or concavely curved surface.

Moreover, it lies within the scope of the invention according to FIG. 6 for the thickness distribution of the base layer to the cover layer to be asymmetrical over the width of the strip. FIG. 6 shows an example in which the thickness of the base layer 3 decreases from left to right and, accordingly, the thickness of the cover layer 4 increases from left to right. The structuring is thus formed here by an “angled” boundary surface.

FIG. 7 shows a modified embodiment in which the structuring forms a groove 8 that is used to receive an insert 9. In the illustrated embodiment, this insert is an LED light strip.

FIGS. 1 to 7 show embodiments in which the cover layer 4 completely covers the base layer 3, so that the visible surface is formed completely by the cover layer 4. In contrast, FIG. 8 shows a modified embodiment in which the cover layer 4 only partially covers the base layer 3 (over its width) so that a portion of the base layer 3 is exposed without being covered by the cover layer 4 and thus forms a part of the visible surface of the strip.

1. An edge strip for fixing to a narrow edge of a furniture panel, work plate, or similar material panel, the edge strip comprising
a base layer of a thermoplastic plastic and having a structured outer face and
a cover layer on the base layer made of a transparent or translucent thermoplastic plastic,
the outer face of the cover layer forming at least part of the visible surface of the edge strip and its inner face being completely or partially in surface contact with the profiled outer face of the base layer.

2. The edge strip defined in claim 1, wherein the base layer and the cover layer are unitarily connected to one another.

3. The edge strip defined in claim 2, wherein the base layer and the cover layer are made by coextrusion or post-coextrusion or by aftercoating and interconnected.

4. The edge strip defined in claim 1, wherein the base layer is transparent or translucent.

5. The edge strip defined in claim 1, wherein the base layer is opaque.

6. The edge strip defined in claim 4, wherein the inner face of the base layer is provided with a decorative imprint, a decorative film, or a paint coating that is visible through the cover layer and the base layer.

7. The edge strip defined in claim 1, wherein the outer face of the base layer is provided with a decorative imprint, a decorative film, or a paint coating, that is visible through the cover layer.

8. The edge strip defined in claim 1, wherein the inner face of the base layer is provided with an adhesion-promoting layer or a meltable layer for fixing to the panel edge.

9. The edge strip defined in claim 1, wherein the inner face of the base layer is flat.

10. The edge strip defined in claim 1, wherein the outer face of the cover layer is flat and smooth or arcuate and smooth.

11. The edge strip defined in claim 1, wherein the outer face of the cover layer is provided with a finish film or paint.

12. The edge strip defined in claim 1, wherein the base layer is made of PMMA, PS, ABS, PC, PVC, PET, PP, PP copolymer, PE copolymer, EVA, EMA, or TPU.

13. The edge strip defined in claim 1, wherein the cover layer is made of PMMA, PS, ABS, PC, PVC, PET, PP, PP copolymer, PE copolymer, EVA, EMA, or TPU.

14. The edge strip defined in claim 1, wherein the edge strip has a thickness of 1 mm to 10 mm or a width of 2 mm to 100 mm.

15. The edge strip defined in claim 1, wherein the average thickness of the cover layer is 10% to 80% of the average thickness of the base layer.

16. The edge strip defined in claim 1, wherein the structuring of the base layer includes a groove into which an an LED light strip can be or is placed.

17. A material furniture panel, with an edge strip defined in claim 1 fixed thereto.
